(19) United States
(12) Patent Application Publication
(10) Pub. No.: US 2011/0250837 A1
(43) Pub. Date: Oct. 13, 2011

(54) COMMUNICATIONS SYSTEM AND METHOD USING A PART OF HUMAN BODY AS AN ANTENNA IN A BODY AREA NETWORK

(75) Inventors: Jung-Hwan Hwang, Daejeon (KR); Kyung-Soo Kim, Daejeon (KR); Jung-Bum Kim, Daejeon (KR); In-Gi Lim, Daejeon (KR); Chang-Hee Hyoung, Daejeon (KR); Hyung-Il Park, Daejeon (KR); Sung-Eun Kim, Seoul (KR); Tae Wook Kang, Daejeon (KR); Hey-Jin Myoung, Seoul (KR); Kyung-Hwan Park, Daejeon (KR); Seok-Bong Hyun, Daejeon (KR); Byoung-Gun Choi, Daegu (KR); Tae-Young Kang, Seoul (KR); Sung-Weon Kang, Daejeon (KR)

(73) Assignee: ELECTRONICS AND TELECOMMUNICATIONS RESEARCH INSTITUTE, DAEJEON (KR)

(21) Appl. No.: 13/140,412

(22) PCT Filed: Dec. 3, 2009
(86) PCT No.: PCT/KR09/07189

§ 371 Date: Jun. 16, 2011

(30) Foreign Application Priority Data
Dec. 24, 2008 (KR) 10-2008-0133596
Jun. 22, 2009 (KR) 10-2009-0055585

(51) Int. Cl. H04W 4/00

(52) U.S. Cl. 455/39

(57) ABSTRACT

There is provided a communications system and method using a part of human body as an antenna in a body area network, and more particularly, to a communications system and method enabling wireless communications using a low frequency band without the use of a bulky antenna in such a manner that a transmitting-side communications device applies electrical signals to a human body via a transmitting-side coupler to allow a part of human body to act as an antenna, and electrical signals, occurring in another part of human body due to radio frequency (RF) signals, are transferred to a receiving-side communications device via a receiving-side coupler.

### TECHNICAL FIELD

The present invention relates to a communications system and method using a part of human body as an antenna in a body area network, and more particularly, to a communications system and method enabling wireless communications using a low frequency band without the use of a bulky antenna in such a manner that a transmitting-side communications device applies electrical signals to a human body via a transmitting-side coupler to allow a part of human body to act as an antenna, and electrical signals, occurring in another part of human body due to radio frequency (RF) signals, are transferred to a receiving-side communications device via a receiving-side coupler.

### BACKGROUND ART

Many people in a modern society habitually carry portable devices such as personal digital assistants (PDAs), cellular phones, and portable medical devices. In order to transmit and receive a variety of data between these portable devices, a network is established in an area surrounding a human body, and such a network is defined as a body area network.

A data transmission method used in this body area network may be a wired transmission method using cables and a wireless transmission method using radio frequency (RF) waves. The wired transmission method provides the advantages of data security and rapid transmission speeds, but it requires the carrying of wire devices such as cables. On the other hand, the wireless transmission method provides for convenient data transmission, but wireless channels are greatly influenced by a human body itself or human body movement. That is, a human body that is a dielectric body having very high wave loss properties is located in wireless channels between communications devices in the body area network, so signal loss is very high. Also, line of sight and non-line of sight wireless channels are repeatedly formed between communications devices according to human body movement, so signal loss variation across the wireless channels can be extremely high, thereby causing difficulties in stable channel construction.

In order to solve these problems, a low frequency band needs to be used. The low frequency band is advantageous over a high frequency band in that it features a reduction in the loss of RF waves caused by the human body and a reduction in signal loss variation caused by human body movement due to weak wave linearity. However, the size of an antenna required for wireless transmissions tends to be proportional to the wavelength of a utilized frequency, so that in the case of the use of the low frequency band, a very large-sized antenna is required.

### DISCLOSURE OF INVENTION

### Technical Problem

An aspect of the present invention provides a communications system and method using a part of human body as an antenna in a body area network. The communications system and method enables wireless communications using a low frequency band without the use of a bulky antenna in such a manner that a transmitting-side communications device applies electrical signals to a human body via a transmitting-side coupler to allow a part of human body to act as an antenna, and electrical signals, occurring in another part of human body due to radio frequency (RF) signals, are transferred to a receiving-side communications device via a receiving-side coupler.

### Solution to Problem

According to an aspect of the present invention, there is provided a communications system using a part of human body as an antenna in a body area network, the communications system including: transmitting-side and receiving-side communications devices transmitting and receiving data signals via wireless transmissions; transmitting-side and receiving-side couplers transferring the data signals between the transmitting-side and receiving-side communications devices and a human body; and transmitting-side and receiving-side impedance matching devices implementing impedance matching between the transmitting-side and receiving-side communications devices and the transmitting-side and receiving-side couplers.

The transmitting-side communications device may apply transmission data signals in the form of electrical signals to the human body via the transmitting-side coupler to allow the electrical signals to flow through one side of the human body, and radio frequency waves may be radiated from the one side of the human body into the atmosphere.

The receiving-side communications device may receive electrical signals, occurring in the other side of the human body due to the radio frequency waves radiated from the one side of the human body, via the receiving-side coupler.

The transmitting-side and receiving-side couplers may be configured as signal electrodes to transfer the data signals. Also, the transmitting-side and receiving-side couplers may further include respective ground electrodes connected to a ground of the transmitting-side and receiving-side communications devices.

The transmitting-side and receiving-side couplers may or may not contact the human body.

The transmitting-side and receiving-side couplers may be separately formed outside the transmitting-side and receiving-side communications devices to directly contact the human body when the transmitting-side and receiving-side couplers contact the human body. The transmitting-side and receiving-side couplers may be included inside the transmitting-side and receiving-side communications devices, respectively, when the transmitting-side and receiving-side couplers do not contact the human body.

The transmitting-side and receiving-side impedance matching devices may be differently configured on the basis of variable impedance according to whether the transmitting-side and receiving-side couplers contact the human body or do not contact the human body.

According to another aspect of the present invention, there is provided a communications method using a part of human body as an antenna in a body area network, the communications method including: applying, by a transmitting-side communications device, transmission data signals in the form of electrical signals to a human body via a transmitting-side coupler to allow electrical signals to flow through one side of the human body; radiating radio frequency waves from the one side of the human body flowing through the electrical signals into the atmosphere; and receiving, by a receiving-side communications device, electrical signals, occurring in the other side of the human body due to the radio frequency waves radiated from the one side of the human body, via a receiving-side coupler.

### Advantageous Effects of Invention

As set forth above, according to exemplary embodiments of the invention, a part of human body is used as an antenna during wireless communications between the transmitting-side and receiving-side communications devices, thereby establishing stable wireless channels using a low frequency band without the use of a bulky antenna.

Also, the impedance matching devices, provided between the transmitting-side and receiving-side communications devices and the transmitting-side and receiving-side couplers, allow impedance, which is variable according to whether the transmitting-side and receiving-side couplers contact the human body or not, to be matched, thereby reducing signal loss.

Furthermore, the ground electrodes connected to the ground of the communications devices are further included, whereby stronger signals are applied to the human body or received therefrom.

### BRIEF DESCRIPTION OF DRAWINGS

FIG. 1 schematically illustrates a communications system using a part of human body as an antenna in a body area network according to an exemplary embodiment of the present invention;

FIG. 2 illustrates a detailed configuration for a communications system using a part of human body as an antenna in a human area network according to an exemplary embodiment of the present invention; and

FIG. 3 is a graph illustrating the input impedance of couplers when the couplers contact a human body and when the couplers do not contact the human body in a communications system using a part of human body as an antenna.

### BEST MODE FOR CARRYING OUT THE INVENTION

Exemplary embodiments of the present invention will now be described in detail with reference to the accompanying drawings. However, detailed descriptions related to well-known functions or configurations will be ruled out in order not to unnecessarily obscure subject matters of the present invention. Throughout the drawings, the same reference numerals will be used to designate the same or like parts.

In addition, throughout the specification, it will be understood that when an element is referred to as being connected to another element, it can be both directly connected to the other element or intervening elements may be present. Also, unless explicitly described to the contrary, the word include and variations such as includes or including, will be understood to imply the inclusion of stated elements but not the exclusion of any other elements.

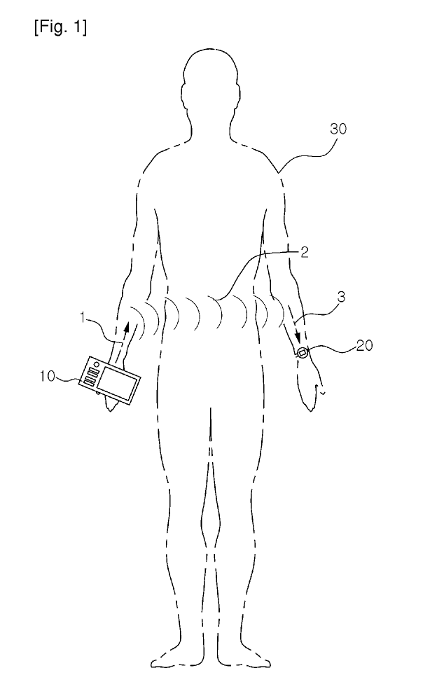

FIG. 1 schematically illustrates a communications system using a part of human body as an antenna in a human area network according to an exemplary embodiment of the present invention.

A human body has conductivity, albeit of a low level. This conductivity may allow the human body to be used as an antenna for wireless transmissions.

Specifically, when a transmitting-side communications device 10 applies electrical signals to one side of a human body 30, the electrical signals 1 flow through the human body 30. Accordingly, a part of human body 30 radiates radio frequency (RF) waves 2 into the atmosphere, thereby acting as a transmitting-side antenna.

Also, when the other side of the human body 30 is exposed to the RF waves 2 radiated into the atmosphere, the electrical signals 3 flow through the human body 30 and are transmitted to a receiving-side communications device 20, whereby the part of human body 30 acts as a receiving-side antenna.

Like this, the transmitting-side and receiving-side communications devices 10 and 20 forming the body area network enable the part of human body 30 to act as the antenna, thereby implementing wireless communications without a separate antenna apparatus.

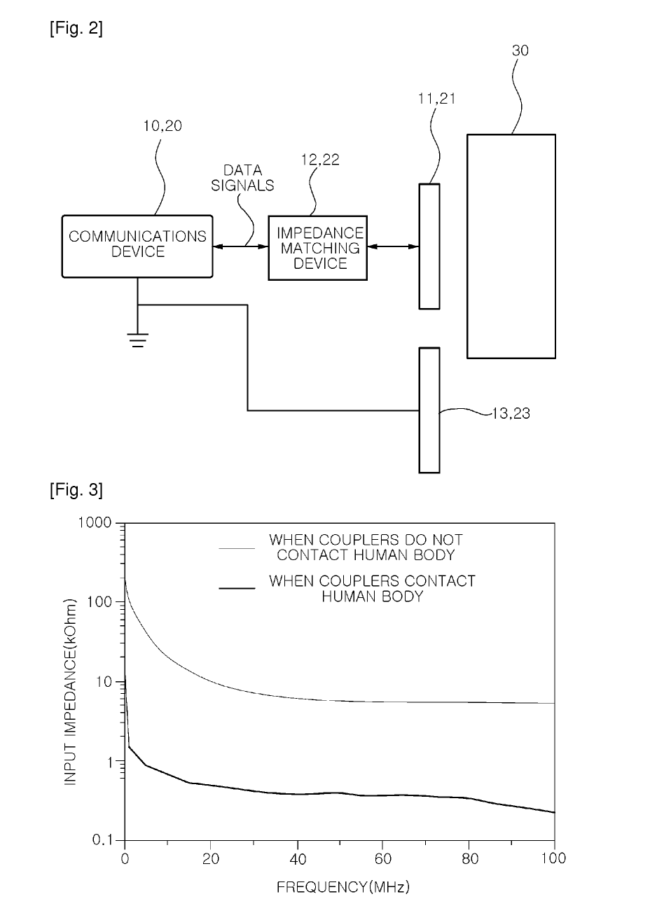

FIG. 2 illustrates a detailed configuration for a communications system using a part of human body as an antenna in a human area network according to an exemplary embodiment of the present invention. The communications system includes the transmitting-side and receiving-side communications devices 10 and 20, transmitting-side and receiving-side couplers 11 and 21 included in the transmitting-side and receiving-side communications devices 10 and 20, respectively, and impedance matching devices 12 and 22 for impedance matching between the transmitting-side and receiving-side couplers 11 and 21 and the transmitting-side and receiving-side communications devices 10 and 20.

Here, the communications devices 10 and 20 are wireless communications devices transmitting and receiving data using a wireless transmission method. For example, the communications devices 10 and 20 may vary irrespective of device types under the condition that communications devices, such as personal digital assistants (PDAs), cellular phones, and medical devices, can establish the body area network. The communications devices 10 and 20 are divided into the transmitting-side and receiving-side communications devices 10 and 20 for convenience of explanation, but they have the same function in view of data transmission.

Also, the couplers 11 and 21 transfer transmission and reception data signals in the form of electrical signals between the communications devices 10 and 20 and the human body 30. The couplers 11 and 21 are divided into the transmitting-side and receiving-side couplers 11 and 21 for convenience of explanation, but they have the same function.

The transmitting-side communications device 10 applies transmission data signals in the form of electrical signals to the human body 30 via the transmitting-side coupler 11.

The receiving-side communications device 20 receives reception data signals in the form of electrical signals flowing through the human body via the receiving-side coupler 21.

The transmitting-side and receiving-side couplers 11 and 21 may be configured as signal electrodes, and they may contact the human body or may not contact the human body.

FIG. 3 illustrates the input impedance of couplers when the couplers contact a human body and when the couplers do not contact the human body in the communications system using the part of human body as the antenna. As shown in FIG. 3, the transmitting-side and receiving-side couplers 11 and 21 have a low impedance value when they contact the human body as compared to when they do not contact the human body, due to the high dielectric properties of the human body.

Therefore, the present invention includes the impedance matching devices 12 and 22 between the transmitting-side and receiving-side communications devices 10 and 20 and the transmitting-side and receiving-side couplers 11 and 21. For example, as shown in FIG. 3, the impedance matching devices 12 and 22 may be configured to be suitable for respective impedance, whereby the transmitting-side and receiving-side couplers 11 and 21 may apply stronger signals to the human body 30 and receive them from the human body 30 when they do not contact the human body as well as when they contact the human body.

Meanwhile, when the couplers 11 and 21 contact the human body 30, they may be configured to add ground electrodes 13 and 23 connected to a ground of the communications devices 10 and 20 as well as signal electrodes serving to transfer data signals. In this case, strong signals flow through the human body between the signal electrodes and the ground electrodes. That is, signal strength becomes strong as compared to when the couplers 11 and 21 are configured as only the signal electrodes. Therefore, stronger signals may be applied to the human body 30 or received therefrom.

On the other hand, when the couplers 11 and 21 do not contact the human body, that is, when there exist other materials such as air or clothes between the couplers 11 and 21 and the human body 30, a signal loss may additionally occur due to impedance mismatching. However, the impedance matching devices 12 and 22 as described above may reduce such a signal loss. Therefore, even though the couplers 11 and 21 may not contact the human body 30, the part of human body 30 may be used as the antenna by applying electrical signals to the human body 30. In this case, since the couplers 11 and 21 do not need to contact the human body 30, convenience of use may be enhanced.

Also, when the couplers 11 and 21 need to contact the human body 30, they may be separately formed outside the communications devices 10 and 20. However, when the couplers 11 and 21 do not need to contact the human body 30, they may be formed inside the communications devices 10 and 20.

While the present invention has been shown and described in connection with the exemplary embodiments, it will be apparent to those skilled in the art that modifications and variations can be made without departing from the spirit and scope of the invention as defined by the appended claims.

1. A communications system using a part of human body as an antenna in a body area network, the communications system comprising:
transmitting-side and receiving-side communications devices transmitting and receiving data signals via wireless transmissions;
transmitting-side and receiving-side couplers transferring the data signals between the transmitting-side and receiving-side communications devices and a human body; and
transmitting-side and receiving-side impedance matching devices implementing impedance matching between the transmitting-side and receiving-side communications devices and the transmitting-side and receiving-side couplers.

2. The communications system of claim 1, wherein the transmitting-side communications device applies transmission data signals in the form of electrical signals to the human body via the transmitting-side coupler to allow the electrical signals to flow through one side of the human body, and radio frequency waves are radiated from the one side of the human body into the atmosphere.

3. The communications system of claim 2, wherein the receiving-side communications device receives electrical signals via the receiving-side coupler, the electrical signals occurring in the other side of the human body due to the radio frequency waves radiated from the one side of the human body.

4. The communications system of claim 1, wherein the transmitting-side and receiving-side couplers are configured as signal electrodes to transfer the data signals.

5. The communications system of claim 4, wherein the transmitting-side and receiving-side couplers further include respective ground electrodes connected to a ground of the transmitting-side and receiving-side communications devices.

6. The communications system of claim 1, wherein the transmitting-side and receiving-side couplers contact the human body or do not contact the human body.

7. The communications system of claim 6, wherein the transmitting-side and receiving-side couplers are separately formed outside the transmitting-side and receiving-side communications devices to directly contact the human body when the transmitting-side and receiving-side couplers contact the human body, and the transmitting-side and receiving-side couplers are included inside the transmitting-side and receiving-side communications devices, respectively, when the transmitting-side and receiving-side couplers do not contact the human body.

8. The communications system of claim 6, wherein the transmitting-side and receiving-side impedance matching devices are differently configured on the basis of variable impedance according to whether the transmitting-side and receiving-side couplers contact the human body or do not contact the human body.

9. A communications system using a part of human body as an antenna in a body area network, the communications system comprising:
a communications device transmitting and receiving data signals via wireless transmissions;
a coupler transferring the data signals between the communications device and a human body; and
an impedance matching device implementing impedance matching between the communications device and the coupler.

10. The communications system of claim 9, wherein the communications device applies transmission data signals in the form of electrical signals to the human body via the coupler to allow the electrical signals to flow through one side of the human body, and radio frequency waves are radiated from the one side of the human body into the atmosphere.

11. The communications system of claim 9, wherein the communications device receives electrical signals via the coupler, the electrical signals occurring in the other side of the human body due to the radio frequency waves radiated from the one side of the human body.

12. The communications system of claim 9, wherein the coupler is configured as a signal electrode to transfer the data signals.

13. The communications system of claim 12, wherein the coupler further includes a ground electrode connected to a ground of the communications device.

14. The communications system of claim 9, wherein the coupler contacts the human body or does not contact the human body.

15. The communications system of claim 14, wherein the coupler is separately formed outside the communications device to directly contact the human body when the coupler contacts the human body, and
the coupler is included inside the communications device when the coupler does not contact the human body.

16. The communications system of claim 14, wherein the impedance matching device is differently configured on the basis of variable impedance according to whether the coupler contacts the human body or does not contact the human body.

17. A communications method using a part of human body as an antenna in a body area network, the communications method comprising:
applying, by a transmitting-side communications device, transmission data signals in the form of electrical signals to a human body via a transmitting-side coupler to allow electrical signals to flow through one side of the human body;
radiating radio frequency waves from the one side of the human body flowing through the electrical signals into the atmosphere; and
receiving, by a receiving-side communications device, electrical signals via a receiving-side coupler, the electrical signals occurring in the other side of the human body due to the radio frequency waves radiated from the one side of the human body.
